(19) United States
(12) Patent Application Publication
(10) Pub. No.: US 2009/0012704 A1
(43) Pub. Date: Jan. 8, 2009

(54) Retail Store Product Location Service System and Method

(76) Inventors: Bruce Franco, Cambridge, MA (US); Maureen Franco, Cambridge, MA (US); William Robinson, Baltimore, MD (US); Sanjay Patel, Brookline, MA (US)

Correspondence Address: MILLS & ONELLO LLP, ELEVEN BEACON STREET, SUITE 605, BOSTON, MA, 02108, US

(21) Appl. No.: 12/163,272

(22) Filed: Jun. 27, 2008

Related U.S. Application Data
(60) Provisional application No. 60/947,574, filed on Jul. 2, 2007.

(51) Int. Cl. G01C 21/00; G06F 7/20; G06F 15/16; G06F 17/30

(52) U.S. Cl. 701/200; 707/3; 707/4; 709/206; 707/E17.014

(57) ABSTRACT

In accordance with the present invention, provided is a product location system comprising an interface to a network accessible by a user equipment and configured to receive a user request for location of at least one product and a store/product location system comprising a database identifying stores and product locations within the stores and configured to return a product location within a store for each of the at least one product.

### CROSS REFERENCE TO RELATED APPLICATIONS

The present application claims the benefit of priority under 35 USC 119(e) from co-pending, commonly owned United States Provisional Patent Application Ser. No. 60/947,574 entitled Retail Store Product Location Service System and Method, filed Jul. 2, 2007, the entire contents of which are hereby incorporated by reference.

### FIELD OF INTEREST

The present inventive concepts relate to the field of systems and methods used in retail shopping.

### BACKGROUND

According to an article in the Wall Street Journal on Jun. 27, 2007 entitled Big Boxes Aim to Speed UP Shopping, “The average user at a Wal-Mart Supercenter spends 21 minutes in the store, but locates only 7 of the 10 items on his or her shopping list.” The article further states that as a result of the same problem, stores like Home Deport and Best Buy are implementing measures to assist users in locating products, speed their checkout, and make their shopping experience less frustrating. Many consumers find this basic problem to be more frustrating in a food market where there are very few sales people roaming the aisles.

Retail store product location can be even more frustrating in a grocery store where there are usually no sales people manning the aisles and very few stock attendants on the sales floor. Except for the addition of specialty departments such as bakeries, gourmet foods, and prepared foods, the basic grocery store design has not evolved much from its original configuration that assumed users would walk up and down every aisle on every visit because they would only shop once a week to stock up.

Nowadays, a significant percentage of people make more than one weekly trip and buy many fewer items per trip because restaurants have replaced a large percentage of home cooking and people also want their food fresh. As a result, finding products in a grocery store is now much more of a problem as people make specialty trips and stores grow larger.

An example of how frustrating this problem can be is highlighted by a supermarket visit to find a fairly common item—honey. After a thorough search of the aisle featuring a legend sign that contained the word “Condiments” in its list, the item was located after futilely walking the entire length of the store looking for an a more appropriate aisle, and then finally standing in line to inquire at the information desk located on the opposite end of the store. As it turned out, the honey was actually located in an aisle whose sign read as follows: “Stationary—Greeting Cards—Cereal—Tea—Coffee—Pancake Mix”. As a result, it took approximately 10 minutes to find just one item.

Retailers have invested most of their time, effort, and innovation money into the operations side of the business, or more specifically in supply chain management and inventory control systems with most of their high tech budget going into “planogram” software, and automated marketing and analytic systems that can model sales forecasts based on varying conditions—like promotions and product placement. Other than traditional marketing endeavors, very little attention has been paid to the consumer experience. That situation as well as the increasing severity of the consumers' problem of locating products within big box stores are two of the reasons that the Jun. 27, 2007 Wall Street Journal article received so much discussion within the retail industry.

Currently available electronic solutions to the problem tend to be brute force type solutions that throw money at the problem, but have met with only limited success in delivering the convenience that consumers have become accustomed to in today's environment of instant access and satisfaction through technology. Existing electronic solutions that have been suggested include computer information kiosks, shopping carts with computer tablets, and stationary call/help buttons. Current solutions that employ personnel include additional store labor in the aisles and store greeters, or having the checkout personnel ask the user if he was able to find everything on his shopping list. There is also voluminous marketing literature related to improving store signage and optimizing the location of products and groups of products within the store to minimize user frustration.

The primary problem with the current electronic solutions is that their utility to the consumer is a direct function of how many hardware stations are provided for the consumer to access and where those stations are located in the store. The fewer stations available for the consumers to access and the less useful these solutions become. The population of stations within the store is also effectively diminished by the ability of the consumer to locate one, when and where he needs it. Electronic solutions that involve hardware stations to interface with the consumer are also capital intensive, they involve one-off specialty hardware systems, specialized maintenance, are subject to high failure rates due to their inherent exposure to and handling by the shopping public, require a consumer learning curve to operate requiring even more of the user's valuable time, and rapidly become outdated. Other issues include cleanliness and some user's reluctance to put their hands on a keyboard that many others before them have touched.

Solutions that involve additional labor tend to be the highest cost solutions and have the disadvantage of requiring additional training and deliver inconsistent results because of inherent differences in the people providing the service. Even if personnel are trained solely to help customers find anything and everything in a store, they are still subject to unavailability due to regular breaks, personal needs, vacations, sickness, and turnover. Furthermore, customers may be embarrassed to ask a store employee to help them locate personal items, such as hygiene items and medications,

The signage and product placement marketing solutions continue to be improved, but no one set of logic will work for all people and no matter how well a store is arranged there will always be products that people will either be unable to locate or require searching multiple possible areas within a store in order to find it.

To date, a solution that leverages existing consumer hardware and enables, among other things, easy product location has yet to be developed.

### SUMMARY OF INVENTION

In accordance with one aspect of the present disclosure, provided is a product location system comprising: an interface to a network accessible by a user equipment and configured to receive a user request for location of at least one product; and a store/product location system comprising a database identifying stores and product locations within the stores and configured to return a product location within a store for each of the at least one product.

The system can further comprise a response system configured to parse the product location request to determine a set of keywords and to submit the keywords to the store/product location system.

The user equipment can include a stationary device.

The user equipment can include a wireless mobile device.

The system can further comprise a routing system configured to determine a route through the store configured to locate the product.

The routing system can be further configured to generate a graphical map depicting the route and the at least one product.

The system can further comprise a location service configured to provide a location of the user equipment in relation to the store.

The user equipment can be a mobile device and the system can further comprise an auto-initiation module configured to initiate a product location session with the mobile device when the location of the mobile device is determined by the location service to be proximate to the store.

The system can be configured to initiate a product location session in response to a message from the user equipment.

The system can further comprise a messaging service interface configured to send text messages to the user equipment. The messaging service can include SMS, MMS, or both.

The system can further comprise a Web application server configured to deliver Web page to the user equipment.

In accordance with other aspects of the invention, provided is a product location system comprising: an interface to a network accessible by a user equipment and configured to receive a user request for location of at least one product; a location service configured to provide a location of the user equipment; a response system configured to parse the product location request to determine a set of keywords and to submit the keywords to the store/product location system; a store/product location system comprising a database identifying stores and product locations within the stores and configured to return a product location within a store for each of the at least one product; and an auto-initiation module configured initiate a product location session with the mobile device when the location of the mobile device is determined by the location service to be proximate to the store.

The user equipment can include a wireless mobile device.

The system can further comprise a routing system configured to determine a route through the store configured to locate the product.

The routing system can be configured to provide an optimized route that minimizes path length through the store.

The routing system can be further configured to generate a graphical map depicting the route.

The system can further comprise a messaging service interface configured to send text messages to the user equipment. The messaging service can include SMS, MMS, or both.

In accordance with other aspects of the invention, provided is a method of locating products in stores, using one or computer systems configured to communicate with electronic user equipment and to access at least one database identifying stores and product locations within the stores, the method comprising: receiving a user request for a location of at least one product; determining a product location within a store for each of the at least one product from the database identifying stores and product locations within the stores; and returning the product location for each of the at least one product to the user equipment.

The method can comprise determining a route through the store configured to locate the at least one product.

The method can comprise generating a graphical map depicting the route and the at least one product.

The method can comprise providing a location of the user equipment in relation to the store, wherein the user equipment is a mobile device.

The method can comprise auto-initiating a product location session with the mobile device when the location of the mobile device is determined by the location service to be proximate to the store.

The method can comprise initiating a product location session in response to a message from the user equipment, wherein the user equipment is a mobile device.

The method can comprise communicating with the user equipment using a messaging service configured to exchange text messages with the user equipment.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 provides a block diagram that illustrates various aspects of a product location system in accordance with the present invention;

FIGS. 2A-2B provide flowcharts depicting embodiments of methods of user-interaction with the product location system, in accordance with the present invention;

FIG. 3 is a flowchart depicting an embodiment of mapping functionality that can be provided by the product location system, in accordance with the present invention; and

FIGS. 4A-4C are embodiments of screenshots that can be rendered on a mobile device in response to information sent by the product location system, in accordance with the present invention.

### DETAILED DESCRIPTION OF PREFERRED EMBODIMENTS

Hereinafter, aspects of the present invention will be described by explaining illustrative embodiments in accordance therewith, with reference to the attached drawings. While describing these embodiments, detailed descriptions of well-known items, functions, or configurations are typically omitted for conciseness.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

In accordance with the present invention, a product location system and method are provided, which can be collectively referred to as a product location service. The purpose of this service is to help retail users/users more quickly and conveniently locate products in a store to make their shopping more successful by helping the user find more items on their shopping list and to make their shopping trip more efficient by minimizing their physical shopping effort and the time it takes to conduct their shopping. A user can make use of his computer and/or mobile device with a computer-automated system or a manual call center at the service end of the transaction.

In the exemplary embodiment described herein, the product location service allows users to locate products via a Website and/or a mobile device (e.g., cell phone, personal digital assistant (PDA), or the like—collectively, user equipment (UE)) —in a product location session. The interaction between a user and the product location service could take any of a variety of forms, including text message (SMS), Multimedia Messaging Service (MMS) Internet communication, interactive voice response (IVR), instant message (IM), or e-mail to quickly provide product location information to the user. The product location service can take the form of a Location Based Service (LBS) that uses the location of a user's mobile device as part of providing the service. In some forms, access to product location information, e.g., in the form of a list or a graphical store routing map or both, of the store could be provided, e.g., with an indication of the product location. And, in some forms, the communication with the user could include communication with a live call center having access to product location information.

The resultant product location information could be provided in various formats to the user, including voice, text message, instant message, graphic map similar to maps provided on the Internet for driving directions, and/or as a simple list specifying the aisle identification number and additional detail, such as distance down the aisle, the side of the aisle where the product is located, and the shelf or height above the floor. In addition to specific products, the product location service could also enable a user to find a category of products or a type of product, or a store department. For example, if a category of products were Beverages, a product type could be Coffee, and a product could be Folgers Coffee Classic Decaffeinated Blend For All Makers 13 Oz Can. The message to the user could indicate that the selected one of the foregoing is located in, for example, aisle 6 or aisle 6 right-hand side or aisle 6 right-hand side, about 5 feet down on top shelf. Other levels of detail could be provided. The product location service could also provide information to the user as to whether or not the item he is searching for is in stock.

The product location service can be implemented locally in a particular store or in a chain of stores, with or without the use of a website, or some combination thereof. For example, in an in-store embodiment, a phone number could be posted in the store (e.g., at the entrance) that anyone with a cell phone could call to locate his target retail item (or product), e.g., via interactive voice response or call center help.

For people having a phone with text messaging capability, the store could post a text standard message set (SMS) numerical address (a.k.a. “short code”) that the user could use to text in product information, such as the category, name, or manufacturer, etc. of the product that the user is trying to locate. And the reply text from the product location service could provide a location for the product in, for example, word format. For example, a user in a food market could text the store's short code with the word “anchovies” and the reply text message could read “Aisle 3, right side, half way down, top shelf”. For users with a smart phone the reply text message could also provide an Internet URL link that would show the product location on a map. For in-store applications the user's mobile device could connect to the product location system via wireless cell phone networks, wireless local area network (WLAN), such as Wireless Fidelity (WiFi), and/or satellite networks, such as the Global Positioning System (GPS) or Assisted GPS (A-GPS), as examples.

In some embodiments, a dedicated Internet website can be included that would allow the user to locate his items in a particular store in advance of his arrival at the store and could provide the additional benefit of having a shopping list printed out along with the product location data and/or a routing map. The map could show the basic layout of the store, as well as the suggested path for the user to walk though the store that would be automatically routed by the product location service to minimize the user's walking distance while collecting all of his listed items. Alternative route optimizations could be requested by the user that would, for example, allow the user to collect the smallest items on his list first or the heaviest items last. An Internet application could be implemented that aggregates numerous stores so a user only has to visit one website to develop location lists for his entire shopping trip, which could include a grocery store, a building supply store, big box store, and so on. The website can also be available to Web-enabled mobile devices, for example accessible by users already in the store. In such cases, the product location data and/or routing map could be displayed on the user's mobile device, printed at the store, or both.

The invention can take numerous forms from a most basic form where a user with no prior knowledge walks into the store and sees a sign on the entrance door (or hanging elsewhere in the store) that provides an SMS short code and the simple instruction to text the short code with any product the customer needs help finding, to a more complex solution that requires the user's prior knowledge and voluntary opt-in or subscription to access such a service. The various embodiments can also be classified based on whether the user's interface with the product location service is a mobile wireless device or a stationary computer, whether the user's interface device can access the product location service through the Internet or not, whether the service only works within the local vicinity of the store (e.g. any system employing WiFi, Bluetooth, etc.), and they can be classified as to whether each use of the system is user-initiated or automatically initiated by the product location service, e.g., working in conjunction with an LCS/LBS.

In each embodiment that involves a mobile device where the user initiates the product location service (i.e., mobile originated—MO), there is a corresponding embodiment that can be automatically initiated by the product location service. Embodiments that are automatically initiated can require the voluntary opt-in or subscription by the user and can employ the use of location services (LCS) an/or location based services (LBS) that determine or detect the proximity of the user to a retail store employing the product location service in order to trigger a communication with the user for the purpose of minimizing the user's effort to interface with the product location service. Several examples of automatically initiated (i.e., mobile terminated—MT) embodiment can include:
1. When a participating user gets within a specified distance from the store (plus or minus LCS/LBS tolerance that can vary with the LCS/LBS employed), e.g., within 100 yards of a store on the user's product location service subscription list (e.g., Home Depot, WalMart, etc.), one of several communications with the user's wireless mobile device could be automatically triggered;
2. The user could be sent an SMS text message saying “Reply with product type, category, name or brand to obtain product location within Home Depot,” that way the user only has to click reply and type in the product the user's looking for and hit send or speak the reply into the mobile device;
3. A client-side application could be automatically launched on a smart phone, for example, that would connect to a the store search URL so that the user just has to enter or say his product name/brand; and/or
4. A call center operator could call the user, welcome him to the store, and ask him if there is anything he needs help finding.

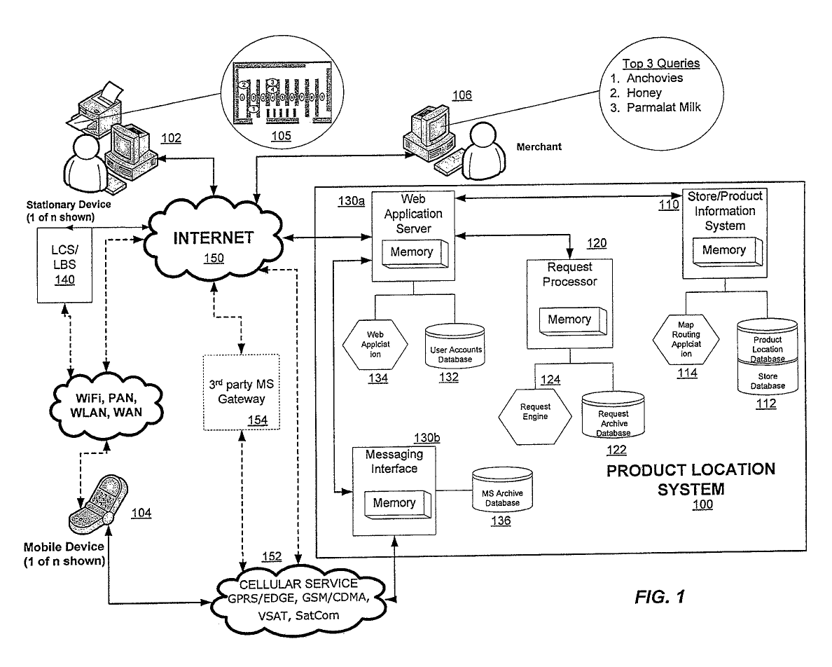

FIG. 1 provides a block diagram that illustrates various aspects of an embodiment of a product location system 100 in accordance with the present invention. The product location system 100 is comprised of hardware, software, and communications equipment necessary to implement a product location service. The actual hardware and software included by the product location system 100, as well as the building block components it integrates, will differ depending on the form of the invention being implemented. Therefore, while several hardware and software components are shown in FIG. 1, the actual combination thereof will depend on the particular embodiment being implemented. Thus, not all of the hardware and software components in FIG. 1 are necessary in each embodiment of the invention. As will be appreciated by those skilled in the art, the hardware, software, and communications equipment of the product location system 100 can be co-located, remote to each other, or some combination thereof.

In FIG. 1, the product location system 100 includes Internet/Web access and/or a messaging service (MS) interface (e.g., Short Message Service (SMS) and/or Multimedia Message Service (MMS)) access, as examples. Similar to paging, SMS is a service for sending short text messages to mobile phones, for example. MMS is a store-and-forward method of transmitting graphics, video clips, sound files and short text messages over wireless networks using the WAP protocol. MMS also supports e-mail addressing, so the device can send e-mails directly to an e-mail address. The most common use of MMS is for communication between mobile phones.

More particularly, the product location system 100 of the present embodiment includes a store/product information system 110 including store and product location information, a request processor 120, a Web application server 130a and an MS interface 130b. The Web application server 130a enables user interaction via the Internet 150 and the MS interface enables interaction via any of a number of wireless networks 152. A user stationary device 102, which is a remote non-store device, (e.g., a personal computer, laptop, and the like) and the mobile device 104 (e.g., cell phone, PDA, etc.) can be collectively referred to as UE, as previously mentioned. With these components, a user can provide store and product identifications from its UE to the request processor 120, via the networks 150, 152, and the request processor 120 can retrieve corresponding product location information specific to the identified store from the store/product location information system 110.

As will be appreciated by those skilled in the art, the stationary device 102 could be a personal computer, workstation or the like. The stationary device 102 can be configured to access the product location system 100 via the Internet 150 and Web application server 130a, using a broadband modem, wireless router, or equivalent. The stationary device 102 could also include or be connected to additional hardware peripherals, such as a printer. The types of stationary devices and networks via which they could access the product location system 100 are not inherently limited, and include those now known and hereafter developed.

The Web application server 130a can provide a website through which the user can access the product location system 100, using Web application 134. Through the Web application server 130a the user can be provided with text descriptions, voice messages, graphical store routing maps, and the like. An advantage to the user of using stationary device 102 accessing the Web application server 130a is that it allows the user to determine the location of one or more of the products on his shopping list before he embarks on his shopping trip, thus allowing him the opportunity to print out the product locations or send it to mobile device 104. A compelling use of the Web application server 130a would be for the user to input his entire shopping list and use the routing application 114 of the store/product information system 110, which can optionally be provided, to present a shopping route through the store, preferably optimized to let the user collect the listed items with the shortest possible walking distance or with saving the heaviest or largest items for last, as examples. Routes can be optimized in any number of manners, according to the preferences of the user. The shopping list (and optional route) could be displayed via the stationary device 102 and/or the mobile device 104, printed from either, or electronically ported from one to the other, or some combination thereof.

The Web application server 130a can also include a user account database 132 configured to store information about registered users of the product location system 100. The accounts could include user preferences, including stores for which the user would like to have the product location services provided. When a LCS and or LBS forms part of the product location system, the user account could identify those stores for which the user would like to be contacted as he gets close thereto. The Web application server 130a could also include user login information, and Web page content and information.

To enable a form of text or voice message communication with a mobile device 104 (e.g., a cell phone, PDA or the like) the product location system 100 includes the MS interface 130b that can enable interaction via a variety of different types of wireless networks and services 152 (e.g., cellular services using Global System for Mobile Communication (GSM)/Time Division Multiple Access (TDMA), Enhanced Data Rate GSM for Evolution (EDGE)/TDMA, and/or 3^{rd} Generation (3G)/Code Division Multiple Access (CDMA), General Packet Radio Service (GPRS), and/or satellite-based services using Very Small Aperture Terminal (VSAT), as examples). The MS interface 130b can include an MS archive database 136 configured to archive MS traffic through the MS interface 130b, e.g., SMS and/or MMS message traffic.

An MS gateway 154 can also be provided that enables communication via the Internet 150. The MS gateway 154 can provide interactive text messaging access to the product location system 100. The MS gateway 154 can be incorporated as a hardware solution in the product location system 100, but could also be a provided as a 3^{rd} party commercial service, such as www.mBlox.com, that would aggregate and distribute SMS text messages and/or MMS messages, communicate with the product location system 100 through the Internet 150, and act as the agent for the product location system 100 to obtain the wireless cellular carrier approvals.

The mobile device 104 uses wireless networks to receive one or more of the following services—voice, SMS, MMS, GPS, the mobile web, and Internet access, as examples. The mobile device 104 would typically be a cellular phone or cellular smart phone, but could also include any of the following types of mobile devices—satellite phone, PDA, mini-PC, laptop computer, and mobile devices designed with the primary purpose of accessing the Internet. The mobile device 104 would typically operate on a wireless cellular transmission system (including all of its proprietary variations), but could also operate on one or more of the following telecommunication transmission methods - radio, WiFi (including its variations such as WiMax (see Air Interface Standard, IEEE 802.16)), Bluetooth, and satellite. The types of mobile devices and networks via which they could access the product location system 100 are not inherently limited, and include those now known and hereafter developed.

The store/product information system 110 includes an electronic product location database 112 comprising product location information for one or more stores. The product location information documents the location of products within a given store. This information can be continually updated whenever the retailer puts a new product on display or relocates a product already on display. The location of each product can be indexed relative to the physical layout (e.g. aisles, display fixtures, signage, checkout counters, etc.), physical geometry of the store architectural structure (walls, floors, rooms, ceiling, etc.) and/or map of the store. The location of each product can also be indexed relative to an absolute geographic mapping index, such as latitude and longitude coordinates generated by a GPS system. The database entry for each product in the store could also include generic descriptors and keywords, which could identify the product category, product type, product name, brand name, manufacturer, and other product specific identification terminology that the consumer may use when attempting to locate the product. The generic descriptors and keywords can, for example, be indexed in a hierarchical format for classification purposes so that all keywords are ultimately associated with generic categories relating to departments or product display areas within the store.

The product location database 112 can be created by accessing or exporting data from a store's existing information management systems, which could include databases associated with inventory control and/or planogram software; or it could be created with the assistance of electronic equipment such as a bar code reader, GPS device, radio frequency identification (RFID), etc.; or it could be created by manual text entry into a database template. The product location database 112 information for the store (e.g., a map with product locations) can be a standalone component generated specifically for and kept internal to the product location system 100, or it can be an existing system residing in a database associated with the store's information technology (IT) systems; or it can be provided as a third party service that interfaces with either the store's IT systems or product location system 100, or both. The product location database 112 may or may not be associated with the store's inventory management system.

A routing application 114 can be included as part of the store/product information system 110 to generate graphical information representations for assisting the user in locating one or more products. For example, using data in the product location database 112 the routing application 114 could be configured to generate a map 105 for the purpose of providing the user with a visual reference of the product location within the store. The product location could be illustrated on the graphical map with respect to the physical layout (e.g. aisles, display fixtures, signage, checkout counters, etc.) and/or physical geometry of the store architectural structure (walls, floors, rooms, ceiling, etc.) of the store. And the location of the product could be shown with respect to the physical layout and/or geometry of the store architectural structure, such as with the example map 105.

The graphical map can be dimensionally proportional, partially dimensional and partially schematic, or entirely schematic. The graphical map could be a plan view of the store layout, or a portion thereof, but could be represented three dimensionally. The location data required to develop the graphical map could be imported from the product location database 112, it could be manually input to the routing application 114, or the routing application 114 could call for the data from the product location database 112, as required. While not apparently currently provided, Autodesk, Inc. of California (see www.autodesk.com) provides computer aided design (CAD) software, as an example, that could potentially be configured or adapted to generate such maps. Otherwise, stores maps with associated product locations could be built via other means, such as by adapting existing “planogram” software solutions, which help merchants plan their product layouts and facings within the context of store shelving and display fixtures.

The graphical map may include routing through the store for the user to collect the items on his shopping list using the most efficient path through the store possible—based on his preference of ordering the items according to distance, size, or weight. The routing can be indicated on the graphical map by showing a path through the store and/or by simply numbering the items or using graphical item indicators (e.g. “X”, dots, circles, targets, pushpins, or other icons) in the optimized order.

The graphical map can be displayed and printed via stationary device 102 and/or displayed on mobile device 104. In other embodiments, the graphical map can be printed at the store and picked up by the user there. When the user is operating mobile device 104 in the store and a LBS is employed that can operate indoors, the user's location (either static when the query is submitted or dynamic) with respect to the product being located can also be shown on the graphical map.

The request processor 120 includes a request archive database 122 and a request engine 124. The request engine carries out the functionality of the request processor, including accessing store/product information system 110 and communication with Web application server 130a. Requests can be stored in the request archive database 122. Stored requests can provide useful information to merchants 106 about which products are most frequently searched. In the example of FIG. 1, the merchant 106 could determine that the top three items for which a location was requested were: 1. Anchovies, 2. Honey, and 3. Parmalat Milk. Such information could be used by the merchant 106 to rearrange product locations, adjust product levels, improve signage, and so on.

The request processor 120 is configured to receive the user's input from the Web application server 130a, to which the SMS interface 130b is coupled in the present embodiment. The request engine 124 interprets the user's request by parsing the user's input and comparing relevant parsed data to the product data and keywords contained in the product location database 112. The store/product information system 110 returns to the request processor 120 the most specific product location result from within the hierarchical index that it can match within a reasonable probability. For example, the hierarchical index for an Aluminum Decking Screw in a building supplies store, such as Home Depot, may contain the following keywords listed here in order from most generic first to most specific last: Hardware—Screws—Decking Screws—Stainless Steel Decking Screws—Three Inch. Each of the keywords is associated with an increasingly specific store location, such as Hardware (Aisles 4 and 5)—Screws (Aisle 4)—Decking Screws (Aisle 4; Left Side, Half-Way Down; Shelves 2, 3, 4, 5)—Stainless Steel Decking Screws (Aisle 4; Left Side, Half Way Down; Shelves 2, 3)—Three Inch (Aisle 4; Left Side, Half Way Down; Shelf 2).

Continuing this example from the user's perspective, assume that the user operating mobile device 104 texts the exact words “Deck Screw” in an SMS message to the product location system 100 using the short code for that particular Home Depot. The text is received by the MS interface 130b and passed to Web application server 130a, which in turn passes it to the request processor 120. Then the request processor 120 accesses the store/product information system 110 to determine the product location from the product location database 112 using the words “Deck Screw.” And the store/product information system 110 returns the product location for “Decking Screws” as “Aisle 4; Half Way Down; Shelves 2, 3, 4, 5.” This information is passed to mobile device 104 via the Web application server 130a and MS interface 130b.

The store/product information system 110 can be configured to return results based on exact matches, a probability of a match, or both. For instance, in the above example, the store/product information system 110 could calculate that there is a 95% probability of a match with “Decking Screws” and then return the product location as “Aisle 4; Half Way Down; Shelves 2, 3, 4, 5.”

Should the store/product information system 110 detect multiple possible matches then it could return a list of the most specific hierarchical level it could determine for each possible match within a probability threshold. Therefore, instead of returning a product location result to the user, the store/product information system 110 could return a request that the user select the item number for most probable product category, type or name from a list of the possibilities. In response to that user selection, the store/product information system 110 could then provide the product location.

The request processor 120 can be internal to the product location 100, or it could be provided as a third party service that interfaces with the product location system 100. As an example, the information query Web site known as www.4info.com is one type of system that could be configured to function as the request processor 120. This system enables a user to access the 4Info system by texting to its short code “44636,” using SMS. Various United States Published Patent Applications provide information relating to underlying technologies for accomplishing such text messaging, including U.S. Patent Publication Nos. 20070294725 entitled Message-To-WAP Link For Content And Advertising; 20070112739 entitled Intelligent Mobile Search Client; 20060184625 entitled Short Query-Based System And Method For Content Searching; and 20020147704 entitled System And Method For Searching Disparate File Systems.

The product location system 100 can include mechanisms or interface with systems that determine a user's location. Location can be determined by any of a number of systems, as will be appreciated by those skilled in the art. Basically, location can be treated physically or by proximity. Physical location sensors vary and use different approaches for determining location. GPS satellites and mobile phone towers are two typical types of physical location sensors. Physical location sensors can provide either position or proximity information. Position sensors often determine location within a coordinate system, such as latitude, longitude, and latitude—GPS does this. Latitude-longitude-altitude coordinates are suitable for describing points on the globe, so would be effective in determining a user's proximity to a store implementing the product location service. However, current latitude-longitude-altitude do not work as well for describing points indoors. Proximity sensors tend to be less exact (e.g., within close or distant range of a sensor) than latitude-longitude-altitude sensors. But proximity sensors with overlapping detection regions can form the basis of position sensors effectively indoors, such as wireless access points positioned throughout a location. Thus, proximity sensors can be particularly useful within a store for determining a user's location within the store and/or relative to a product. Position information can be determined via triangulation or trilateration, as is known in the art. Both techniques use the geometry of triangles to calculate the relative position between points. Triangulation uses both distance and angle measurements, whereas trilateration uses only distance measurements.

Location of, for example, mobile device 104, can be determined by a LoCation Service (LCS), and then used in a Location Based Service (LBS). That is, an LCS is generally considered to be a service that generates and provides location data, e.g., location of a mobile device. An LBS is generally considered to be service that uses knowledge of the mobile device's location (i.e., the location data) to a provide value based on mobile device's location. In some embodiments, the product location service can receive LCS location data and serve as an LBS by providing store and/or product location information based on the LCS data. Therefore, a LCS provider 140 is shown as providing such location data to the product location system 100. The routing application 114 of the product location system 100 can use the user location data to show the user within the map, if one is generated, for example.

Beyond locating the user within a map of a store or relative to a location/product in a store, and LCS/ LBS can be used for other purposes within the context of the present invention. For example, the proximity of the user to a retail store that uses the product location service could be determined using any one of numerous LCS/LBS methodologies currently in commercial use, such as GPS, Cell-ID, wireless cellular (e.g., OTDOA—Observed Time Difference of Arrival, E-OTD—Enhanced Observed Time Difference, AGPS—Assisted GPS, AFLT—Advanced Forward Link Tirlateration, EFLT—Enhanced Forward Link Tirlateration) or WiFi triangulation (WiFi-MAC (Media Access Control)), etc. The LBS may originate the necessary location position data of the user, or it may receive such data from a LCS, most typically a wireless cellular carrier service or the GPS. The LBS could require the explicit consent of the user to allow his location information to be provided by the LCS and used by the LBS and/or the product location system 100; and may require the user to activate the location capability of his mobile device to make it available to the LCS/LBS.

The input from the LCS/LBS provides the location coordinates of the user and when the user's location matches the coordinates (within in a specified tolerance) of any store on the user's subscription list, a wireless signal would be transmitted to the user's mobile device to trigger one of a variety of auto-initiated tasks, such as launching the product location service, which could include launching an application residing on the user's mobile device 104 in some embodiments. Should the LBS detect the user's location at multiple stores employing the product location service because of their adjacent locations, then the user would be presented with a list of the possible stores to select from when he inputs an item to be located. The LCS/LBS could be of a variety that continuously tracks the user's location or it could employ carrier technology or proximity beacon equipment in the vicinity of the store that would only detect the user if he came within a set distance of a store. The LCS/LBS could initiate an automatic (i.e., mobile terminated—MT) action upon detecting that the customer has left the store as well. For example, the product location system 100 could send a text message to mobile device 104 as follows: “Thank you for shopping at Home Depot. You have received a 10% discount coupon in your online account applicable towards your next purchase in any Home Depot.”

The store owner or product location system 100 could also provide a store vicinity or an indoor wireless local area network (WLAN) LCS/LBS that could provide the user detection functions necessary to initiate an automatic action given the user's permission and registration with the product location system 100. In this case WiFi, Bluetooth, or wireless cellular receivers could be employed, similar to the receivers used by www.pathintelligence.com in their FootPath™ solution—as an example. For unregistered users, the LCS/LBS could send a message to the user's mobile device 104 asking if product location assistance is needed and/or if registration with the product location system is desired.

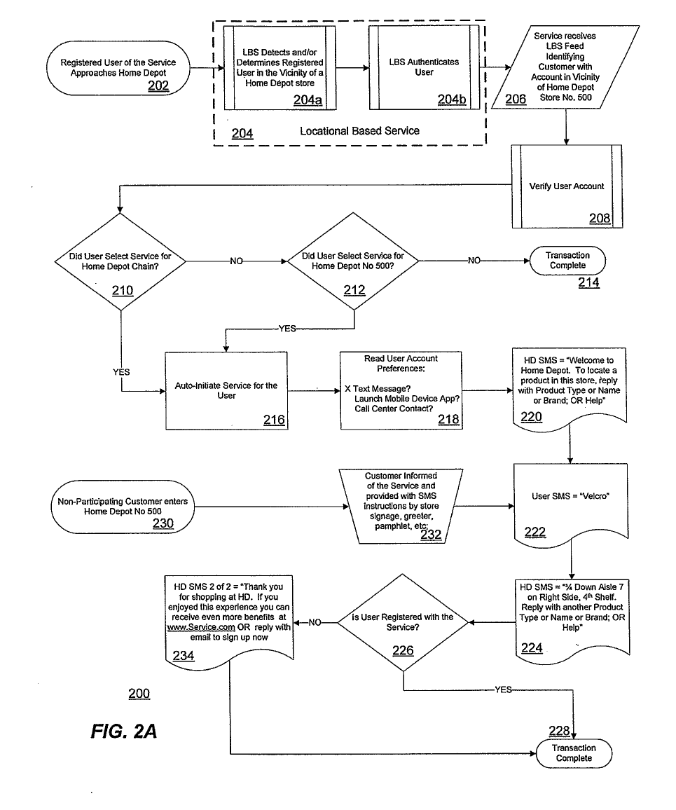

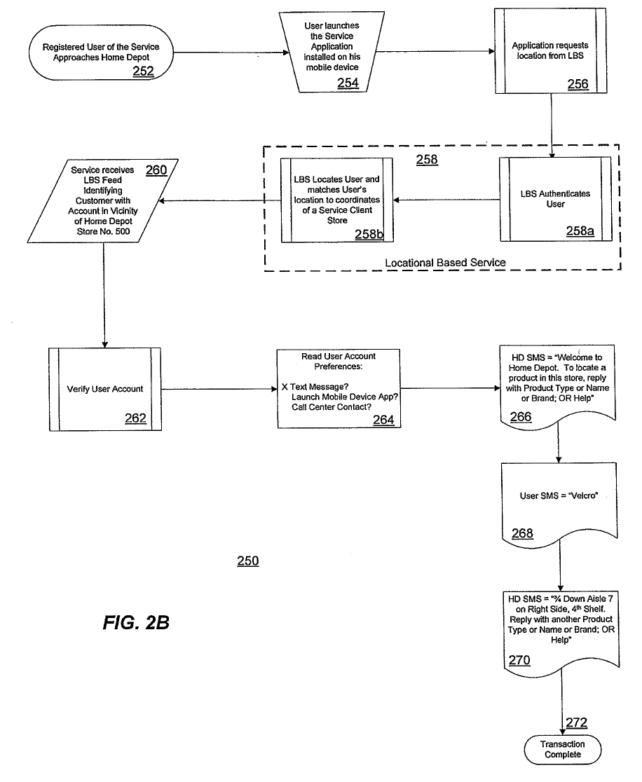

FIGS. 2A-2B provide flowcharts depicting embodiments of methods of user-interaction with the product location system 100.

FIG. 2A provides an embodiment of an auto-initiated method 200 of user interaction with the product location system 100. In step 202 a registered user of the product location service (provided by product location system 100) approaches a Home Depot and in step 204 a LCS/LBS determines the user's location based on the user's mobile device 104. In this embodiment step 204 include a step 204a where the LCS/LBS detects and/or determines the registered user is in the vicinity of the Home Depot and in step 204b initiates authentication of the user. In step 206 the product location system 100 receives the LCS/LBS feed indicating that the registered user has entered the vicinity of a particular Home Depot (e.g., Home Depot store no. 500).

In step 208 the Web application server 130a (which includes account verification functionality in this embodiment) determines, based on the user being identified as a specific registered user, whether the user selected service for the Home Depot chain of stores. If not, the method proceeds to step 212 where a determination is made of whether the user selected service for Home Depot no. 500. If not the transaction completes in step 214. However, if the answer in either of steps 210 or 212 was “yes,” then the method continues to step 218 where the user account preferences are read from user account database 132. The preference can include, as examples, whether the user indicates a preference for contact of: 1) text message, 2) launch mobile device application, or 3) call center contact (i.e., live customer service call). In other embodiments the types of preferences could be different. In step 218, it is indicated by the “X” that the user selected option 1) text message. Therefore, in step 220, a text message is sent from the product location system 100, such as: “Welcome to Home Depot. To locate a product reply with Product Type, Name, or Brand, or HELP.” In step 222 it indicates that the user entered “Velcro” as a text message, which is sent to the product location system 100 via wireless network 152 and MS interface 130b. In step 224 the product location system 100 returns the product location in the form of a reply text message, such as: “¾ Down Aisle 7 on Right Side, 4^{th} Shelf. Reply with another Product Type, Name, or Brand, or HELP.” Assuming in step 226 that the user was a registered user, the transaction completes at step 228—unless the user typed product information for a next product to be located, in which case the process could return to step 222. While not shown, the user could enter multiple product location requests in step 222.

In various embodiments the product location can be made available to non-registered users. In step 230 a non-registered user enters Home Depot no. 500. In step 232 the user is informed of the product location by any one or more of a variety of manners, e.g., newspaper advertisement or in-store signage, information pamphlet, greeter, or a sales flyer. Assuming that it is allowed by relevant laws and regulations for a user to receive unsolicited text messages or other form of communication, the mobile device could also receive a notice of the product location service upon entering the store. If the user decided to use the service he would type in “Velcro” in step 222, as described for the registered user and the method would continue through steps 224-226 and proceed to step 234 from step 226. In step 234 the non-registered user can receive a solicitation message, such as: “Thank you for shopping at HD. If you enjoyed this experience you can receive more benefits at www.PLService.com OR reply with e-mail to sign up now.” This sign-up solicitation can be optionally provided. From there, the transaction can complete at step 228, with sign up being conducted outside of this part of the method.

FIG. 2B provides an embodiment of a user-initiated method 250 of user interaction with the product location system 100. In step 252 a registered user enters the vicinity of a Home Depot store. In step 254 the user launches a client-side product location service application on his mobile device 104. The client-side application requests location determination from the LCS/LBS in step 256. Location determination is provided in step 258. In this embodiment, the location determination step 258 includes a step 258a where the LCS/LBS authenticates the user and a step 258b the LCS/LBS locates the user and matches the user's location to coordinates of a store for which the product location service is provided for the user. The method continues to step 260 where the product location service receives the LCS/LBS feed identifying the user within the vicinity of Home Depot store 500. In step 262 the user account is verified by the Web application server 130a. In step 264 where the user account preferences are read from user account database 132. The preference can include, as examples, whether the user indicate a preference for contact of: 1) text message, 2) launch mobile device application, or 3) call center contact (i.e., live customer service call). In other embodiments the types of preferences could be different. In step 264, it is indicated by the “X” that the user selected option 1) text message. Therefore, in step 264, a text message is sent from the product location system 100, such as: “Welcome to Home Depot. To locate a product reply with Product Type, Name, or Brand, or HELP.” In step 268 it indicates that the user entered “Velcro” as a text message, which is sent to the product location system 100 via wireless network 152 and SMS interface 130b. In step 270 the product location system 100 returns the product location in the form of a replay text message, such as: “¾ Down Aisle 7 on Right Side, 4^{th} Shelf. Reply with another Product Type, Name, or Brand, or HELP.” The transaction completes at step 272—unless the user typed product information for a next product to be located.

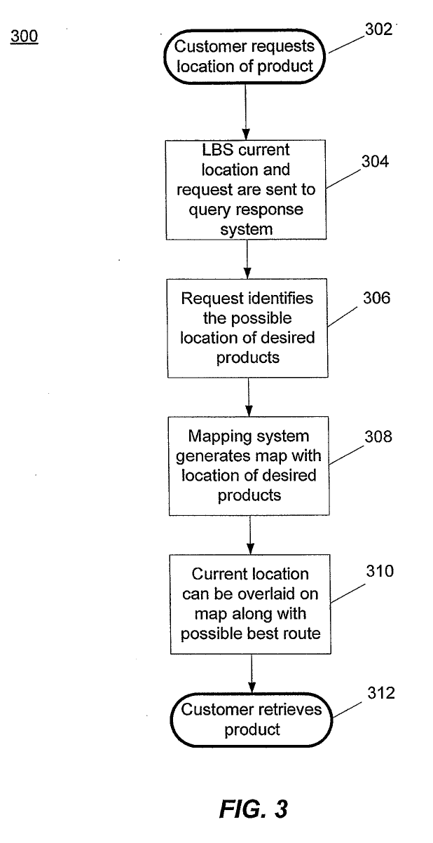

FIG. 3 is a flowchart depicting an embodiment of a method 300 of providing mapping functionality that can be provided by the product location system 100. In step 302 the customer requests location of at least one product. In step 304, the LCS/LBS provides a current location of the user and the user's request is sent to the response system 120 of the product location system 100. In step 306 the store/product information system 110 identifies possible locations of the desired product(s). In step 308 the routing application 114 generates a map with location(s) of the desired product(s). In step 310 the location of the user can be overlaid on the map along with an optimal route through the store to get the desired product(s). In step 312 the user retrieves the desired product(s).

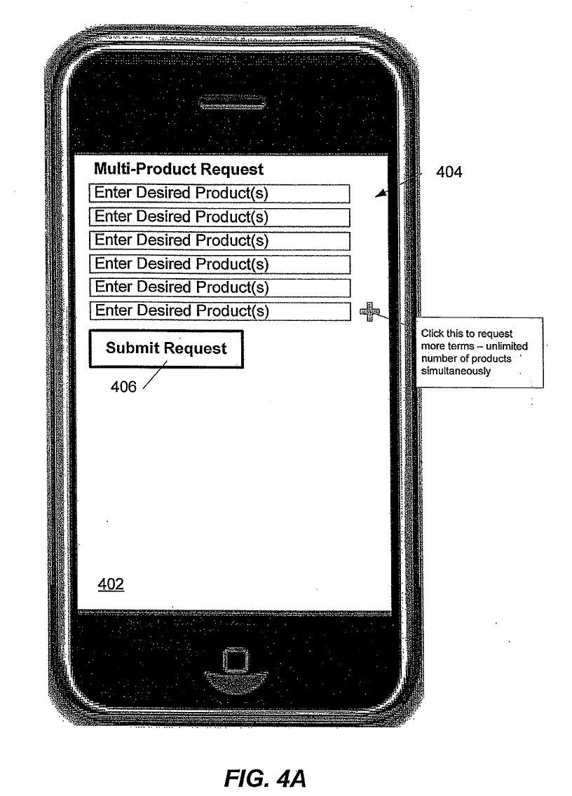

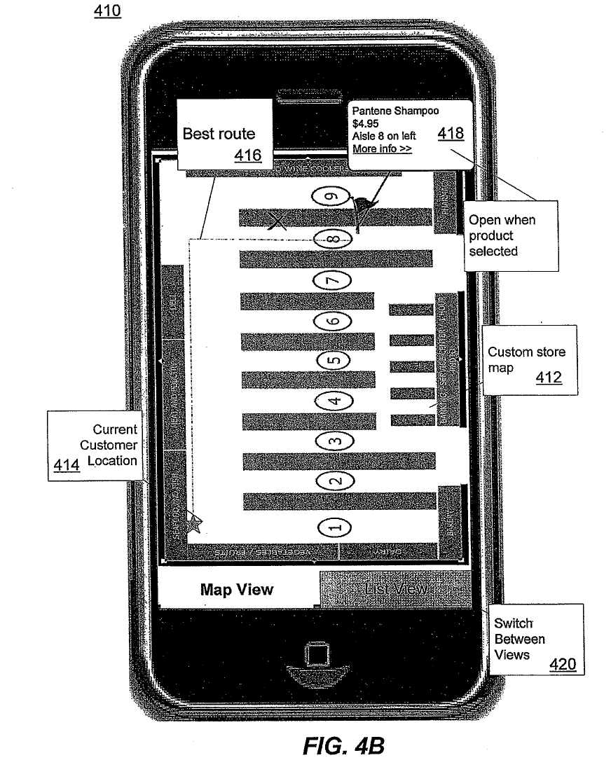

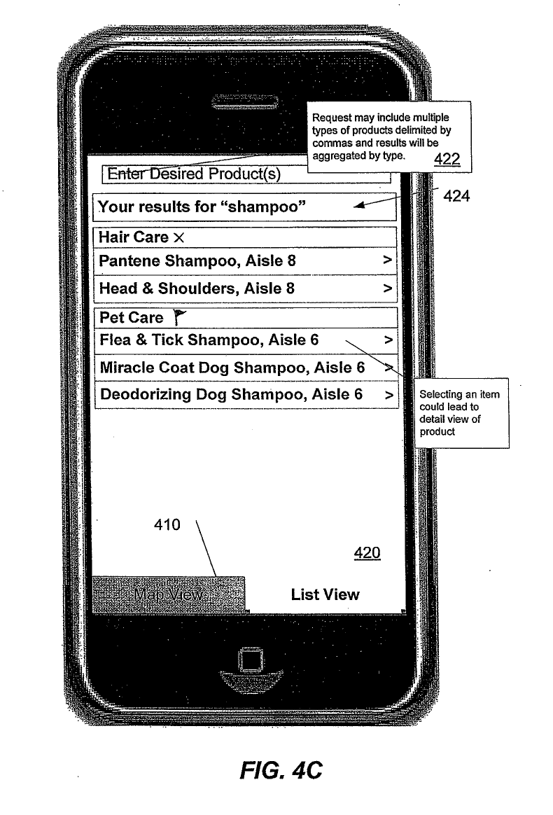

FIGS. 4A-4C are embodiments of screenshots that can be rendered on a mobile device in response to information sent by the product location system, in accordance with the present invention. The steps of the method 300 of FIG. 3 are depicted in the screens of FIGS. 4A-4C. In this these embodiments, the screens are displayed on an iPhone™ by Apple, Inc. as mobile station 104.

FIG. 4A shows a product location request screen 402. This screen 402 includes product location entry fields 404 and a “Submit Query” button 406. The user enters the product name, type, category etc. in the fields and selects the Submit Query to send the request to the product location system 100. Selection of the “+” allows the user to open another field for an additional product information entry.

FIG. 4B shows a map view 410 populated with store and product information provided by the store/product information system 110. In screen 410 there is provided a store map 412 showing store departments and aisles (numbered) as they are arranged within the store. The map can show the location of the user 414, based on the location of the user's mobile device 104. The map can also show a best route 416 through the store. The location of products identified by the user can be shown on the map 412, wherein the best route 416 can provide an optimal path through the store for retrieving the products. The products can be identified on the map by icons, such as a flag. Selection of the product can cause information regarding the product to be displayed in balloon 418. Selection of “List View” button 420 causes the list view of screen FIG. 4C to be displayed.

FIG. 4C shows the list view 420 that includes information from the map view screen 410 of FIG. 4B, but in a list format. The list view screen 420 can include a product entry field 422 to request the product location of a product. In this embodiment it is presumed that the user entered the product type: shampoo. Based on that, a list 424 of possible product information is provided. The items in the list 424 can be selectable to enable the user to identify the item in the list that it was interested in finding when it entered the product term in field 422. “Map View” button 426 is provided to enable the user to switch back to the map view screen 410.

In some embodiments, the product location system could also include Appointment Scheduling capability, i.e., an ability for a user to schedule an appointment with the retail store staff with his user equipment (e.g., PC or cell phone). Since a lot of people go into stores like Home Depot, for example, with problems or projects and not a complete shopping list this capability can prove very helpful to certain users, and would provide significant value to the retail store. A user could make an online appointment or text request in advance of his shopping trip. However, the capability could include the option for a user to schedule that appointment while in the store. For example, a text reply to a user request could read like this: “Bob Jones can meet you at the information Desk in 20 minutes to discuss your problem. Reply YES to confirm appointment or NO to decline.” This scheduling could be managed by the Web application server 130a, in correspondence with the user's account, or a separate module could be added for such a function.

In some embodiments, the product location system could also include a Cumulative Online Shopping List capability, i.e., an ability to generate and maintain lists for each type of store, as well as multiple lists per store, that can be nicknamed by the user showing the weekly, yearly items, etc. from the user's individual product lists. The Cumulative Online Shopping List can be made available to the user in an online session so that he only has to check mark the items he wants to build his shopping list. This list capability could be managed by the Web application server 130a, in correspondence with the user's account, or a separate module could be added for such a function.

In some embodiments, the product location system could also include a Mobile Shopping List Viewing capability, i.e., an ability for registered users to receive their shopping list when a mobile query interaction is user-initiated or auto initiated by LCS/LBS. Sample SMS=“You have 3 items on your Home Depot shopping list. Reply 1 for list OR reply 2 for list with locations OR reply 3 for your Generic List.” Therefore, when the LCS/LBS detects that the user's location is in the vicinity (within 2 miles) of a store for which the user has an existing shopping list, the product location service 100 sends a reminder to the user so that the user can stop in and buy is desired products. This capability can help avoid the common occurrence of a user driving past a store and forgetting to stop in an purchase desired items. This list capability could be managed by the Web application server 130a, in correspondence with the user's account, or a separate module could be added for such a function.

In some embodiments, the product location system could also include a Mobile Shopping List Edit capability, i.e., a capability that enables a user to add items to their list from their mobile devices. As such, this capability makes the product location service a two-way mobile application. Users can text or call in items to their shopping lists so that they can record items whenever they think of them from wherever they are. The interaction can be formatted so the user specifies the product he wants to add to his list, and optionally the store at which he wants to buy it. If no store is specified it is added to a generic list for the user, and then whenever the user is interacting with the product location system 100 at a particular store that carries his generic item he is reminded that it is on his generic list. User generated text to the product location system 100, could take any of a variety of forms, for example: Text Format=[User's Shopping List Name]; [Action—Add, Subtract, or View]; [Item Name] . . . Example=“Weekly Groceries; Add; Eggs.” This list capability could be managed by the Web application server 130a, in correspondence with the user's account, or a separate module could be added for such a function.

In some embodiments, the product location system could also include a Language Translation capability, i.e., for non-English Speaking Users a person could text the product location system 100 with the Spanish word for shampoo return the text location information in the user's language and if he had a smart phone the product location system 100 could return the store plan map and an “x” indicating location. This would be quite a help for non-native speaking users because even if they can find someone to help them in the store, the employee may not speak the user's language. This language translation capability could be managed by the Web application server 130a, in correspondence with the user's account, or a separate module could be added for such a function.

It should be also noted that a text-to-speech and speech-to-text capability could be add so that the user could speak his inputs, have them converted to text for submission via the MS interface 130b, for example. Text messages could be converted to speech at the user's equipment. This could be particularly helpful when driving, since texting and reading is often difficult, if not dangerous, while driving. This list capability could be managed by the Web application server 130a, in correspondence with the user's account, or a separate module could be added for such a function. Or such functionality could be provided on the client side as part of an application that interfaces with the product location system 100.

In accordance with the present invention, an electronic product location solution preferably has a one-to-one ratio of hardware stations to the users so that each user can readily access product location information. The cost to provide each consumer with a hardware station would be prohibitive, therefore, the invention preferably makes use of hardware that is already in the possession of the user; hardware that the user is comfortable with and already knows how to operate; and hardware that the user purchases, gets repaired and updates at his expense—more specifically his personal cell phone, mobile electronic devices (e.g. PDA, WiFi device, etc.), and/or computer. Certain forms of the invention can also be implemented with no additional equipment and zero capital cost for the merchant as he can subscribe to a service as an operating expense and therefore receive a more beneficial tax treatment than had he invested in one of the existing stationary hardware intensive solutions.

In addition to helping users locate products, the users' in-store use of their mobile devices can also provide valuable information to the merchant and other users in the store whenever a user performs an in-store search, as follows: the merchant can receive feedback related to what items are difficult to find in his store by incorporating database archiving and electronic reporting subsystems as optional components of the service so that the user's searches can be saved in the service database and summaries of that information delivered to the merchant via electronic reports; direct query access to the service database of archived consumer searches; or via a continuous Really Simple Syndication (RSS) feed. These reports/queries/feeds will identify the products that user's have the most trouble finding and arm the merchant with the data necessary to improve his in-store product placement and/or signage.

Other users can benefit from a user's search by the retailer incorporating optional in-store electronic sign(s) that could be displayed within the store that would display any service database query the merchant desired. For example, the electronic sign could be used to display the items most searched for by users, as well as their locations within the store. This feature could even be deployed on a departmental basis so that each area or department within the store could be equipped with an electronic sign displaying for example, the top ten most difficult items to find within the subject department. The advantage of using an electronic sign for this purpose is that the data could be continually and automatically updated depending on changing conditions, such as the merchant's improvements in product placement and/or signage and their affect on the users' experience.

It should be also noted that a text-to-speech and speech-to-text capability could be add so that the user could speak his inputs, have them converted to text for submission via the MS interface 130b, for example. Text messages could be converted to speech at the user's equipment.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A product location system comprising:
an interface to a network accessible by a user equipment and configured to receive a user request for location of at least one product;
a store/product location system comprising a database identifying stores and product locations within the stores and configured to return a product location within a store for each of the at least one product.

2. The system of claim 1, further comprising:
a request processor configured to parse the product location request to determine a set of keywords and to submit the keywords to the store/product location system.

3. The system of claim 1, wherein the user equipment includes a stationary device.

4. The system of claim 1, wherein the user equipment includes a wireless mobile device.

5. The system of claim 1, further comprising:
a routing system configured to determine a route through the store configured to locate the at least one product.

6. The system of claim 5, wherein the routing system is further configured to generate a graphical map depicting the route and the at least one product.

7. The system of claim 1, further comprising:
a location service configured to provide a location of the user equipment in relation to the store.

8. The system of claim 7, wherein the user equipment is a mobile device and the system further comprises:
an auto-initiation module configured to initiate a product location session with the mobile device when the location of the mobile device is determined by the location service to be proximate to the store.

9. The system of claim 1, wherein the system is configured to initiate a product location session in response to a message from the user equipment.

10. The system of claim 1, further comprising:
a messaging service interface configured to send text messages to the user equipment.

11. The system of claim 1, further comprising:
a Web application server configured to deliver Web page to the user equipment.

12. A product location system comprising:
an interface to a network accessible by a user equipment and configured to receive a user request for location of at least one product;
a location service configured to provide a location of the user equipment;
a response system configured to parse the product location request to determine a set of keywords and to submit the keywords to the store/product location system;
a store/product location system comprising a database identifying stores and product locations within the stores and configured to return a product location within a store for each of the at least one product; and
an auto-initiation module configured to initiate a product location session with the mobile device when the location of the mobile device is determined by the location service to be proximate to the store.

13. The system of claim 12, wherein the user equipment includes a wireless mobile device.

14. The system of claim 12, further comprising:
a routing system configured to determine a route through the store configured to locate the product.

15. The system of claim 14, wherein the routing system is configured to provide an optimized route that minimizes path length through the store.

16. The system of claim 14, wherein the routing system is further configured to generate a graphical map depicting the route.

17. The system of claim 12, further comprising:
a messaging service interface configured to send text messages to the user equipment.

18. A method of locating products in stores, using one or computer systems configured to communicate with electronic user equipment and to access at least one database identifying stores and product locations within the stores, the method comprising:
receiving a user request for a location of at least one product;
determining a product location within a store for each of the at least one product from the database identifying stores and product locations within the stores; and
returning the product location for each of the at least one product to the user equipment.

19. The method of claim 18, further comprising:
determining a route through the store configured to locate the at least one product.

20. The method of claim 19, further comprising:
generating a graphical map depicting the route and the at least one product.

21. The method of claim 18, further comprising:
providing a location of the user equipment in relation to the store, wherein the user equipment is a mobile device.

22. The method of claim 18, further comprising:
auto-initiating a product location session with the mobile device when the location of the mobile device is determined by the location service to be proximate to the store.

23. The method of claim 18, further comprising:
initiating a product location session in response to a message from the user equipment, wherein the user equipment is a mobile device.

24. The method of claim 18, further comprising:
communicating with the user equipment using a messaging service configured to exchange text messages with the user equipment.
